(19) United States
(12) Patent Application Publication
(10) Pub. No.: US 2018/0326441 A1
(43) Pub. Date: Nov. 15, 2018

(54) TETHERED UNMANNED ROTORCRAFT CHAIN PLATFORM SYSTEM AND LIQUID CONTINUOUS SPRAYING SYSTEM

(71) Applicants: Xiaoyang LIU, Chongqing (CN); Haiying LIN, Beijing (CN)

(72) Inventors: Xiaoyang LIU, Chongqing (CN); Haiying LIN, Beijing (CN)

(21) Appl. No.: 15/774,804

(22) PCT Filed: Nov. 4, 2016
(86) PCT No.: PCT/CN2016/104713

§ 371 Date: May 9, 2018

(30) Foreign Application Priority Data
Nov. 11, 2015 (CN) 201510765256.6

(51) Int. Cl. B05B 13/00; G05D 1/10; B05B 15/62; B05B 1/20; G05D 1/00; B64C 39/02; G05D 1/04

(52) U.S. Cl. CPC B05B 13/005; G05D 1/104; B05B 15/62; B05B 1/20; G05D 1/0027; B64C 2201/148; B64C 39/022; G05D 1/042; B64C 2201/027; B64C 2201/12; B64C 39/024

(57) ABSTRACT

A tethered unmanned rotorcraft chain platform system and liquid continuous spraying system includes a mobile mooring platform, a power system, a tether, multiple unmanned rotorcrafts, a central control system and a liquid continuous spraying system. The power system moves with the mobile mooring platform and provides electrical power to the multiple unmanned rotorcrafts by the tether. The tether is lifted in the air by the multiple unmanned rotorcrafts to form a three-dimensional polyline/curve, so as to avoid or bypass obstacles and adapt to the terrain variation, thus greatly expanding the horizontal space that can be reached by the tethered unmanned rotorcraft chain and its payload. The delivery pipeline of the liquid continuous spraying system is arranged along the tether to continuously supply a liquid such as agricultural chemicals to spraying nozzles mounted on the delivery pipeline or the unmanned rotorcrafts.

### TECHNICAL FIELD

The present invention relates to tethered unmanned rotorcraft system, and to agricultural plant protection performed by tethered unmanned rotorcraft. More specifically, the present invention relates to systems and methods of tethered unmanned rotorcraft chain platform system and liquid continuous spraying system.

### BACKGROUND OF THE INVENTION

The tethered Unmanned Aerial Vehicle (UAV) using the electrical power supplied through the tether, could extend the duration aloft. However, current tethered UAV system is a kind of single line tethering system from a mooring point to the UAV, and the main purpose of the tethered UAV is to add the values of the payload outfitted on the UAV by increasing its altitude vertically over the mooring point. The tethered UAV has no active horizontal maneuverability. In actual complex scenario, the tether is not capable of actively avoid obstacles in horizontal direction around the mooring point, which restricts the horizontal extending range of the tether, and then restricts flight space of the UAV and its payload away from mooring point, especially the horizontal range that UAV and its payload could reach, and also limits the mooring point only to a fixed point or within a limited space restricted by obstacles. Current UAVs used for agricultural plant protection can only take off with limited amount of power and limited amount of agricultural chemicals, and has to land to replenish after the power and/or agricultural chemicals are used up, so it is an intermittent operation and the productivity/efficiency is constrained.

### SUMMARY OF THE INVENTION

The present invention endeavors to improve tether's capability of avoiding obstacles and terrain change adaptive capability in the tethered unmanned rotorcraft chain platform system, and then improve the horizontal range that the tethered unmanned rotorcraft chain platform could reach, improve active terrain change adaptability of the tethered unmanned rotorcraft chain platform system, thus to improve the operational range and the capability of the tethered unmanned rotorcraft chain platform system.

The present invention is a tethered unmanned rotorcraft chain platform system lifted by multiple unmanned rotorcrafts, it comprises mainly: a mobile mooring platform; a power system; a tether; multiple unmanned rotorcrafts; a central control system and a liquid continuous spraying system.

The mobile mooring platform as described carries the power system, the central control system, and a liquid storage tank and a booster pump of the liquid continuous spraying system. The power system as described moves together with the mobile mooring platform and supplies electrical power to the multiple unmanned rotorcrafts through the tether. The liquid continuous spraying system as described comprises the liquid storage tank, the booster pump, a liquid delivery pipeline and spraying nozzles. The liquid storage tank and the booster pump as described are installed on the mobile mooring platform as described. The spraying nozzles as described are arranged along the delivery pipeline and/or on the unmanned rotorcrafts, the delivery pipeline and each unmanned rotorcraft may be provided with a plurality of spraying nozzles. The delivery pipeline as described is connected between the liquid storage tank and the spraying nozzles, is used to continuously transfer liquid to the spraying nozzles. The central control system as described controls the unmanned rotorcrafts through the tether or by wireless means, so that under the control of the central control system, the multiple unmanned rotorcrafts fly cooperatively at different locations in space.

The advantages of the present invention are:
(1) The tether is lifted by multiple unmanned rotorcrafts, so that the tether can form a three-dimensional polyline/curve in space, so as to avoid or bypass obstacles, and better conform and adapt to the terrain change.
(2) It greatly extends the horizontal range that the tethered unmanned rotorcrafts and its payload can reach.
(3) The unmanned rotorcraft chain is supplied with the electrical power through the tether, thus has virtually unlimited duration in air. Whereas, the duration that the existing non-tethered UAV can stay in air is constrained by the capacity of the battery or the amount of the fuel it carried.
(4) The liquid spraying system supplies the liquid to be sprayed by the delivery pipeline which is mounted along the tether. Because it is a continuous liquid supply, the unmanned rotorcrafts need not land to replenish the liquid to be sprayed, thus the operational efficiency/productivity can be improved greatly.

### BRIEF DESCRIPTION OF THE DRAWINGS

FIG. 1 is a schematic diagram of the structure of the unmanned rotorcraft chain platform system and the liquid continuous spraying system according to the present invention.

The reference characters in the FIGURE represent:
1 mobile mooring platform
2 power system
3 tether
4A-4G multiple unmanned rotorcrafts (seven is shown, but not limited thereto)
5 central control system
6 liquid continuous spraying system
7 obstacles.

### DETAILED DESCRIPTION OF THE INVENTION

The present invention will be further described in detail below with reference to the accompanying drawings in the specific embodiment.

The present invention provides a tethered unmanned rotorcraft chain platform system and a liquid continuous spraying system.

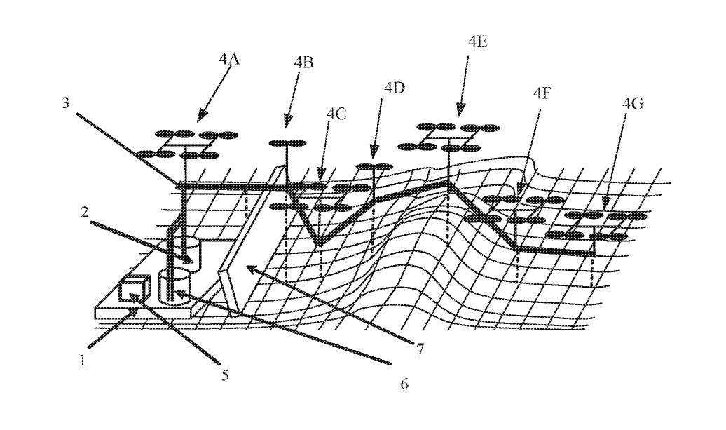

The tethered unmanned rotorcraft chain platform is lifted by multiple unmanned rotorcrafts, as shown in FIG. 1, the tethered unmanned rotorcraft chain platform system and the liquid continuous spraying system mainly comprises: a mobile mooring platform 1, a power system 2, a tether 3 and multiple unmanned rotorcrafts 4 (shown as 4A to 4G in the FIGURE, also named as unmanned rotorcraft chain), a central control system 5 and a liquid continuous spraying system 6. The multiple unmanned rotorcrafts 4A-4G as described cooperates with the liquid continuous spraying system 6 to achieve high efficiency agricultural chemicals spraying operations.

The mobile mooring platform 1 as described is used to carry the power system 2, the central control system 5, a liquid storage tank and a booster pump of the liquid continuous spraying system 6, and other auxiliary equipment. The mobile mooring platform 1 may be a ground platform (such as a ground vehicle), but can also be an aerial platform, such as airships, hot air balloons and other aircraft which can be used as the airborne payload platform. The other auxiliary equipment includes the delivery pipeline, various sensors, etc.

The power system 2 as described moves with the mobile mooring platform 1 and provides electrical power to the multiple unmanned rotorcrafts 4A-4G of the unmanned rotorcraft chain 4 through the tether 3.

The tether 3 as described is used to transmit the electrical power of the power system 2 to the multiple unmanned rotorcrafts 4A-4G connected along the tether 3. The tether 3 is made of metal or contains electric wires.

The multiple unmanned rotorcrafts 4A-4G as described are connected along the tether 3 and work on the electrical power provided by the power system 2. The multiple unmanned rotorcrafts 4A-4G are connected at different positions of the tether 3 with uniform spacing or non-uniform spacing, and generate lift to bring the tether 3 and mission loads (liquid delivery pipeline and other equipment) mounted along tether 3 to the air. Under the control of the central control system 5, the multiple unmanned rotorcrafts 4A-4G are coordinated to fly at different positions in space, thus the tether can form a three-dimensional polyline/curve so that the tether 3 can avoid the obstacle 7 to adapt to the complex terrain changes, so as to greatly improve the horizontal extension capability of the tether 3, and the multiple unmanned rotorcrafts 4A-4G connected with tether 3, especially the distal unmanned rotorcrafts (such as 4G-4C in FIG. 1) has a greatly increased range of motion.

The central control system 5 can centrally manage and coordinate all the unmanned rotorcrafts 4A-4G flying via a wired or wireless means so that the unmanned rotorcrafts can work together to lift the tether 3 and avoid the obstacles 7 and perform a liquid spraying operation.

The liquid continuous spraying system 6 as described pressurizes the liquid in the liquid storage tank with the booster pump and then supplies the liquid to the spraying nozzles through the delivery pipeline installed along the tether 3 and/or on the unmanned rotorcrafts 4 for continuous spraying. The liquid as described could be agricultural chemicals or other liquid that needs to be sprayed.

In the embodiment shown in FIG. 1, seven unmanned rotorcrafts are schematically shown, in order, 4A, 4B, 4C, 4D, 4E, 4F and 4G, which are distributed along the tether 3. As regards the mobile mooring platform 1, when a ground vehicle is selected, the ground vehicle carries the central control system 5, the power system 2, the liquid storage tank and the booster pump. The power system 2 as described supplies electrical power to the seven unmanned rotorcrafts 4A-4G through tether 3. Meanwhile, the central control system 5 transmits control signals to all the unmanned rotorcrafts 4A-4G through the tether 3 or a signal line mounted along the tether 3 in a wired manner or wirelessly (such as WiFi) in order to provide the unmanned rotorcrafts 4A-4G with real-time control signals or commands. The liquid continuous spraying system 6 as described comprises the liquid storage tank, the booster pump, the delivery pipeline and the spraying nozzles, wherein the liquid storage tank and the booster pump as described are mounted on the mobile mooring platform 1, and the spraying nozzles as described are arranged along the tether 3 or on the unmanned rotorcrafts 4A-4G. Any position along the delivery pipeline and/or on all unmanned rotorcrafts can be equipped with a number of spraying nozzles. The delivery pipeline as described is connected between the liquid storage tank and the spraying nozzles to continuously provide liquid to the spraying nozzles. The delivery pipeline as described is made of a flexible material, and the delivery pipeline is arranged along the tether 3.

The application of the tethered unmanned rotorcraft chain platform system and liquid continuous spraying system as described may be done in the following two basic methods: Method A and Method B. Method A and Method B can also be used in combination.

### Method A:

The first step is to move the mobile mooring platform 1 to the required working field, connect the first unmanned rotorcraft 4G to the distal end of the tether 3, start the power system 2 to supply the electrical power to the first unmanned rotorcraft 4G.

The second step: the first unmanned rotorcraft 4G as described works, and lift portion of the tether 3, portion of the delivery pipeline mounted along the tether 3, and the spraying nozzles mounted along the delivery pipeline to the sky diagonally.

The third step: after the tether 3 has been extended for a specified length, connect the second unmanned rotorcraft 4F to the tether 3, meanwhile the power system 2 supplies electrical power to the unmanned rotorcraft 4F, the first and second unmanned rotorcraft (4G and 4F) work cooperatively to lift up a larger portion of the tethers 3, a larger portion of the delivery pipeline and more spraying nozzles mounted along tether 3.

The fourth step: connect in turn more unmanned rotorcrafts to the tether 3, lift more of the tether 3 off and bypass the obstacle 7 to arrive at the working field.

The fifth step: the central control system 5 by controlling the height of the unmanned rotorcrafts, adjust the clearance between the spraying nozzles and the ground as appropriate.

The sixth step: the liquid continuous spraying system 6 installed on the mobile mooring platform 1 pressurizes the agricultural chemicals and supplies them to the spraying nozzles through the delivery pipeline installed along the tether 3. At the same time, control the movement of the mobile mooring platform 1, control the unmanned rotorcraft chain 4 to move synchronously with the mobile mooring platform 1, while automatically avoiding obstacles and adapting to the terrain changes, so that agricultural chemicals spraying can continuously sweep a large area of land to achieve high efficiency operation of agricultural plant protection spraying.

### Method B:

The first step is to move the mobile mooring platform 1 to the required working field, deploy the tether 3 and mount all the unmanned rotorcrafts in place along the tether 3.

The second step: start the power system 2 to supply electrical power to all the unmanned rotorcrafts through the tether 3. The central control system 5 controls all the unmanned rotorcrafts cooperatively to lift the tether 3 and avoid obstacles to move to the work area.

The third step: the central control system 5, by controlling the height of unmanned rotorcrafts, adjusts the clearance between the agricultural chemicals spraying nozzles and the ground as appropriate.

The fourth step: the liquid continuous spraying system 6 installed on the mobile mooring platform 1 pressurizes the agricultural chemicals and supplies them to the spraying nozzles through the delivery pipeline installed along the tether 3. At the same time, control the movement of the mobile mooring platform 1, control the unmanned rotorcraft chain 4 to move synchronously with the mobile mooring platform 1, while automatically avoiding obstacles and adapting to the terrain changes, so that agricultural chemicals spraying can continuously sweep a large area of land to achieve high efficiency operation of agricultural plant protection spraying.

In addition to spraying agricultural chemicals in combination with a continuous liquid spraying system, this tethered unmanned rotorcraft chain platform system serves as a universal platform that can be equipped with various devices and systems to achieve different functions such as:

Multiple cameras and/or lighting equipment can be installed along the tether 3, providing long-term, uninterrupted photographing, surveillance and illumination from multiple angles, especially the cameras and/or the lighting equipment installed on the unmanned rotorcrafts far from the mooring point can take advantage of obstacle avoidance and horizontal extension capabilities of the tether 3 to enable continuous surveillance, photographing, and illumination on the place horizontally far away from the mooring point.

Signaling repeaters can be installed at distal end of the tether 3 to enable signal relaying in complex terrain conditions.

Multiple sensors can be installed along the tether 3 for sweeping over a large area of the land while the mobile mooring platform 1 moves to achieve high efficiency ground exploration.

1. A tethered unmanned rotorcraft chain platform system and liquid continuous spraying system, comprising: a mobile mooring platform, a power system, a tether, multiple unmanned rotorcrafts, a central control system and a liquid continuous spraying system, wherein
the liquid continuous spraying system comprises a liquid storage tank, a booster pump, a delivery pipeline and a plurality of spraying nozzles;
the mobile mooring platform carries the power system, the central control system, and the liquid storage tank and the booster pump of the liquid continuous spraying system;
the power system moves together with the mobile mooring platform and supplies electrical power to the unmanned rotorcrafts through the tether;
the plurality of spraying nozzles are mounted along the delivery pipeline and/or on the unmanned rotorcrafts;
the delivery pipeline is connected between the liquid storage tank and the plurality of spraying nozzles for continuously transferring a liquid from the liquid storage tank to the plurality of spraying nozzles; and
the central control system controls the unmanned rotorcrafts by the tether or by a wireless means, such that the multiple unmanned rotorcrafts fly cooperatively at different locations in space.

2. The tethered unmanned rotorcraft chain platform system and liquid continuous spraying system of claim 1, wherein the tether is made of metal or comprises electric wires.

3. The tethered unmanned rotorcraft chain platform system and liquid continuous spraying system of claim 1, wherein the delivery pipeline is made of a flexible material, and the delivery pipeline is arranged along the tether.

4. The tethered unmanned rotorcraft chain platform system and liquid continuous spraying system of claim 1, wherein the multiple unmanned rotorcrafts are connected to different positions along the tether to lift the tether in the air, the positions of the unmanned rotorcrafts in space are adjustable to drive the tether to form a payload platform in space which has an adjustable three-dimensional continuous polyline/curve shape and is capable of actively avoiding obstacles to adapt to terrain change.

5. The tethered unmanned rotorcraft chain platform system and liquid continuous spraying system of claim 1, wherein the liquid continuous spraying system uses the booster pump to pressurize the liquid stored in the liquid storage tank to supply the liquid to the plurality of spraying nozzles through the delivery pipeline mounted along the tether or on the multiple unmanned rotorcrafts for continuous liquid spraying.

6. The tethered unmanned rotorcraft chain platform system and liquid continuous spraying system of claim 1, wherein the liquid sprayed through the liquid continuous spraying system is continuously supplied through the delivery pipeline mounted along the tether or on the multiple unmanned rotorcrafts, and the continuous liquid spraying system moves with the tethered unmanned rotorcraft chain platform, the height of the spraying nozzles from the ground being adjustable in real time.

7. The tethered unmanned rotorcraft chain platform system and liquid continuous spraying system of claim 1, wherein the mobile mooring platform may be a ground platform with ground mobility or an aerial platform with space mobility.

8. The tethered unmanned rotorcraft chain platform system and liquid continuous spraying system of claim 1, wherein cameras may be installed on the unmanned rotorcrafts and the tether for photo and video capturing; lighting equipment may be installed on the unmanned rotorcrafts and the tether for multi-angle lighting; signal relay equipment may be installed on the unmanned rotorcrafts and the tether to achieve signal relay; sensors may be installed on the unmanned rotorcrafts and the tether to achieve earth exploration.

9. A method of using the tethered unmanned rotorcraft chain platform system and liquid continuous spraying system of claim 1, comprising the steps of:
(1) moving the mobile mooring platform to a working field, connecting a first unmanned rotorcraft to the distal end of the tether, starting the power system to supply electrical power to the first unmanned rotorcraft;
(2) causing the first unmanned rotorcraft to fly and lift a portion of the tether, a portion of the delivery pipeline mounted along the tether, and the spraying nozzles mounted along the portion of the delivery pipeline to the sky at an angle;
(3) after the tether has been extended for a specified length, connecting a second unmanned rotorcraft to the tether, meanwhile the power system supplying electrical power to the second unmanned rotorcraft, whereby the first and the second unmanned rotorcrafts work cooperatively to lift more of the tether, more of the delivery pipeline and more of the spraying nozzles mounted along the tether up in the air;
(4) connecting in turn more of the unmanned rotorcrafts to the tether, lifting up more of the tether while avoiding obstacles;
(5) the central control system controlling the height of the unmanned rotorcrafts to adjust the clearance between the plurality of spraying nozzles and the ground as appropriate; and
(6) the liquid continuous spraying system pressurizing and supplying the liquid to the spraying nozzles through the delivery pipeline installed along the tether; at the same time, moving the mobile mooring platform, controlling the multiple unmanned rotorcrafts to move synchronously with the mobile mooring platform while avoiding obstacles, thereby continuous spraying of the liquid over land may be performed.

10. A method of using the tethered unmanned rotorcraft chain platform system and liquid continuous spraying system of claim 1, comprising the steps of:
(1) moving the mobile mooring platform to a working field, deploying the tether and mounting all the unmanned rotorcrafts along the tether;
(2) starting the power system to supply electrical power to all the unmanned rotorcrafts through the tether, the central control system controlling all the unmanned rotorcrafts to cooperatively lift the tether while avoiding obstacles;
(3) the central control system controlling the height of the unmanned rotorcrafts to adjust the clearance between the plurality of spraying nozzles and the ground as appropriate; and
(4) the liquid continuous spraying system pressurizing and supplying the liquid to the spraying nozzles through the delivery pipeline installed along the tether; at the same time, moving the mobile mooring platform, controlling the multiple unmanned rotorcrafts to move synchronously with the mobile mooring platform while avoiding obstacles, thereby continuous spraying of the liquid over land may be performed.
